(19) United States
(12) Patent Application Publication
(10) Pub. No.: US 2008/0214300 A1
(43) Pub. Date: Sep. 4, 2008

(54) METHODS FOR ELECTRONIC DATA SECURITY AND PROGRAM AUTHENTICATION

(75) Inventors: David C. Williams, Carson City, NV (US); Richard E. Rowe, Las Vegas, NV (US); Binh T. Nguyen, Reno, NV (US)

Correspondence Address: BEYER WEAVER LLP, P.O. BOX 70250, OAKLAND, CA, 94612-0250, US

(73) Assignee: IGT, Reno, NV (US)

(21) Appl. No.: 12/120,205

(22) Filed: May 13, 2008

Related U.S. Application Data
(63) Continuation-in-part of application No. 11/078,966, filed on Mar. 10, 2005.
Application No. 11/078,966 is a continuation-in-part of application No. 10/116,424, filed on Apr. 3, 2002, now Pat. No. 7,168,089.
Application No. 10/116,424 is a continuation-in-part of application No. 09/732,650, filed on Dec. 7, 2000, now Pat. No. 7,127,069.

(51) Int. Cl. G06F 17/00

(52) U.S. Cl. 463/29

(57) ABSTRACT

Apparatus and methods for improving security and preventing tampering in a gaming system are described. In particular, the gaming system may comprise an authorization device that is configured to control a download of gaming data, such as an executable image for generating a game of chance, from a first gaming device to a second gaming device. For each download between two different devices, the authorization device may be operable to generate a unique encryption key pair utilized in the download and determine whether the downloaded data is authentic. The gaming device receiving the download of game data may be configured such that it doesn't utilize the game data until an approval is received from the authorization device.

### RELATED APPLICATION DATA

The present application is continuation-in-part and claims priority under 35 U.S.C. 120 to U.S. patent application Ser. No. 11/078,966, filed Mar. 10, 2005 and entitled “SECURED VIRTUAL NETWORK IN A GAMING ENVIRONMENT,” by Nguyen et al., which is a continuation-in-part of U.S. patent application Ser. No. 10/116,424, filed Apr. 3, 2002 entitled “SECURED VIRTUAL NETWORK IN A GAMING ENVIRONMENT,” by Nguyen et al., now U.S. Pat. No. 7,168,089, each of which is incorporated herein by reference in its entirety and for all purposes.

### TECHNICAL FIELD

The present invention relates generally to gaming devices and systems, and more specifically to security methods for gaming devices.

### BACKGROUND

Casinos and other forms of gaming comprise a growing multi-billion dollar industry both domestically and abroad, with electronic and microprocessor based gaming machines being more popular than ever. A gaming entity that provides gaming services, via stand-alone casino-type machines, may control gaming devices that are globally distributed in many different types of establishments. For example, gaming machines that are stand-alone units, may be placed in casinos, convenience stores, racetracks, supermarkets, bars and boats.

Gaming establishments typically use electronic and microprocessor based gaming machines can include various hardware and software components to provide a wide variety of game types and game playing capabilities. For example, bill validators, coin acceptors, card readers, keypads, buttons, levers, touch screens, displays, coin hoppers, player tracking units and the like are examples of hardware that can be coupled to a gaming machine. Software components can include, for example, boot and initialization routines, various game play programs and subroutines, balance or credit, and payout routines, image and audio generation programs, security monitoring programs, authentication programs and a random number generator, among others. These software components are generally configured to provide these functions for a single gaming machine and each gaming machine typically duplicates the functionality of the other gaming machine in a brick and mortar casino.

In a typical, electronic and microprocessor based gaming machine operated by a casino, such as a slot machine, video poker machine, video keno machine or the like, a game play is initiated through a wager of money or credits that have been deposited directly into the gaming machine in some manner, whereupon the gaming machine determines a game outcome, presents the game outcome to the player and then potentially dispenses an award of some type, including a monetary award, depending upon the game outcome. In this instance, the gaming machine is operable to receive, store and dispense indicia of credit or cash as well as calculate a gaming outcome that could result in a large monetary award. The gaming machine is allowed to operate in this manner because it is placed typically in location that is monitored (e.g., a casino), the gaming machine hardware and software components are secured within a locked cabinet and the gaming machine includes a security system for detecting fraud or theft attempts.

The functions of a stand-alone, gaming machine may augmented via links to other gaming devices. For instance, when connected to other remote gaming devices, a gaming machine may provide or may used as part of an implementation of progressive jackpots, player tracking and loyalty points programs, cashless gaming, and bonusing among other items. Many of these added components, features and programs can involve the implementation of various back-end and/or networked systems, including more hardware and software elements, as is generally known. Nevertheless, the bulk of game play functionality on the gaming machine is provided via hardware and software located on the gaming machine.

Traditionally, as described in the previous paragraphs, casino-style gaming has been provided using self-contained devices, where each machine contains all of the hardware and software required provide a gaming experience, including generating game outcomes, providing a presentation of the game outcome and handling monetary transactions. More recently, client-server system architectures have been developed whereby gaming functions that allow the gaming experience to be generated on a client device are distributed between multiple gaming devices. For instance, a single server can provide game outcome generation for multiple client gaming devices, such as mobile gaming devices, where a presentation corresponding to the game outcome received from the server is generated locally on the client device. The client device may or may not include money-handling capabilities or the security features of a traditional stand-alone gaming machine and, thus, may be implemented as a much simpler and less costly device as compared to the traditional stand-alone gaming machine.

Although some gaming functions have been implemented in a client-server architecture, there are many aspects of managing and provisioning gaming client devices that are still performed manually. For example, in a time consuming process, installing a new game has previously involved manually exchanging an EPROM (e.g. a read-only memory) containing the game on the gaming client device. The software is manually loaded because the gaming software is very highly regulated and in most gaming jurisdictions only approved gaming software may be installed on a gaming machine. Further, the gaming software is manually loaded for security reasons in order to prevent the source code from being obtained by individuals who might use the source code to try to find ways of cheating the gaming machine. Other attributes of gaming machines, such as the denomination, pay tables, etc., are also manually configured for similar reasons.

It would be desirable to provide methods and devices that overcome at least some of these drawbacks of the prior art.

### SUMMARY

Various embodiments of the present invention address the need describe above by providing a gaming system comprising an authorization device that is configured to control a download of gaming data, such as an executable image for generating a game of chance, from a first gaming device to a second gaming device. The authorization device may be configured to monitor and control downloads of game data between a plurality of gaming devices in the gaming system. For each transfer of game data between two different devices in the gaming system, the authorization device may be operable to generate a unique encryption key pair utilized in the download and determine whether the downloaded data is authentic. The gaming device receiving the download of game data may be configured such that it doesn't utilize the game data until an approval is received from the authorization device.

One aspect may be generally characterized as a gaming system comprising a target device, a source device and an authorization device. The target device may comprise i) a first logic device designed or configured to 1) receive encrypted game data from a source device; 2) generate a first value by applying a first one-way function to the encrypted game data; 3) send the first value to an authorization device; 4) receive a decryption key from the authorization device for revealing game data from the encrypted game data; 5) generate a second value by applying a second one-way function to the game data; 6) send the second value to the authorization device, 7) receive an authorization message from the authorization device indicating whether the target device is authorized to use the game data; 8) generate a play of a wager-based game using the game data; ii) a display for displaying an outcome to the wager-based game; and iii) a first communication interface for communicating with the source device and the authorization device.

The source device may comprise i) a memory for storing the game data a second logic device designed or configured to 1) receive an encryption key from the authorization device; 2) embed at least a portion of the encryption key in the game data; 3) to encrypt the game data embedded with at least the portion of the encryption key with the encryption key; 4) to send the encrypted game data to the target device; and iii) a second communication interface for communicating with the authorization device and the target device.

The authorization device may comprise: i) a memory storing the game data wherein the game data is an authorized copy of the game data stored on the source device; and ii) a third logic device designed or configured to receive a plurality of download requests and for each download request, a) to generate a new encryption key pair including the encryption key and the decryption key wherein the new encryption key pair is used only one time; b) to embed at least the portion of the encryption key in the game data in the same manner as the source device; c) to generate a third value by applying the second one-way function to the game data including the embedded encryption key; d) to encrypt the game data embedded with at least the portion of the encryption key with the encryption key; e) to generate a fourth value by applying the first one-way function to the encrypted game data; f) to receive from the target device the first value, g) to compare the first value to the fourth value; h) when it is determined the first value and the fourth value match, to send to the target device the decryption key, i) to receive from the target device, the second value; j) to compare the second value to the third value; k) when it is determined the second value and third value match, to send the authorization message to the target device indicating it is authorized to use the game data it received from the source device.

In particular embodiments, the third logic device may be further designed or configured to send a message to the target device specifying the first one-way function to use, the second one-way function to use or the first one-way function and the second one-way function to use. The first one-way function or the second one-way function may be a hash function. The third logic device may be further designed or configured to select at random the first one-way function to use, the second one-way function to use or the first one-way function and the second one-way function to use.

In addition, the third logic device may be further designed or configured to send a message to the target device including instructions to cease operations and to enter into a tilt state. Also, the third logic device may be further designed or configured to send a message to the target device including instructions to delete the game data or the encrypted game data received from the source device. Further, the third logic device may be further designed or configured to send a message to the target device indicating one or more portions of the game data or one or more portions of the encrypted game data for use with the first one-way function or for use with the second one-way function.

In yet other embodiments, the game data may comprise coding instructions used to generate the wager-based game of chance on the target device. The game data may comprise one of data in a textual format, data in a binary format or combinations thereof. In addition, each time a copy of the game data is sent from the source device, different randomly generated data is embedded in the copy of the sent game data so that a value generated by application of a one-way function to a first copy of the sent game data is different than a value generated by application of the one-way function to a second copy of the sent game data.

In other embodiments, the target device may be designed or configured to only store the game data while in a power-on configuration. Further, the target device may be designed or configured to erase the game data in response to receiving instructions from the authorization device. The target device may be inoperable to generate the play of the wager-based game prior to receiving the game data from the source device. In particular, the target device may be a hand-held gaming device.

The source is a gaming device may be operable to generate the play of the wager-based game. Further, the authorization device and the source device may be a common device. The authorization device, the source device and the authentication device may be communicatively coupled via a network. Further, the authorization device may be located in a secure location separate from the source device. In addition, the authorization device may be operated by a trusted entity where the trusted entity may be a gaming regulator.

Another aspect of the invention pertains to computer program products including a machine-readable medium on which is stored program instructions for implementing any of the methods described above. Any of the methods of this invention may be represented as program instructions and/or data structures, databases, etc. that can be provided on such computer readable media.

Aspects of the invention may be implemented by networked gaming machines, game servers and other such devices. These and other features and benefits of aspects of the invention will be described in more detail below with reference to the associated drawings. In addition, other methods, features and advantages of the invention will be or will become apparent to one with skill in the art upon examination of the following figures and detailed description. It is intended that all such additional methods, features and advantages be included within this description, be within the scope of the invention, and be protected by the accompanying claims.

### BRIEF DESCRIPTION OF THE DRAWINGS

The included drawings are for illustrative purposes and serve only to provide examples of possible structures and process steps for the disclosed inventive systems and methods for providing game services to remote clients. These drawings in no way limit any changes in form and detail that may be made to the invention by one skilled in the art without departing from the spirit and scope of the invention.

FIG. 1 illustrates a block diagram of a gaming system in one embodiment of the present invention.

FIG. 2 is an interaction diagram between a source device, a target device and an authorization device for one embodiment of the present invention.

FIG. 3A is a flow diagram of an exemplary process for verifying the integrity of an executable software program.

FIG. 3B is a diagrammatic representation of an executable software program with markers according to one embodiment.

FIG. 4 is a block diagram of a gaming device, in accordance with one embodiment of the present invention.

FIG. 5 illustrates a perspective view of one embodiment of a client gaming device.

FIG. 6 illustrates a block diagram of a gaming system for other embodiments of the present invention.

FIG. 7 illustrates a network device that may be configured according to some aspects of the invention.

### DETAILED DESCRIPTION

Exemplary applications of systems and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following example should not be taken as definitive or limiting either in scope or setting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used and changes may be made without departing from the spirit and scope of the invention.

Although the present invention is directed primarily to gaming machines and systems, it is worth noting that some of the apparatuses, systems and methods disclosed herein might be adaptable for use in other types of devices, systems or environments, as applicable, such that their use is not restricted exclusively to gaming machines and contexts. Such other adaptations may become readily apparent upon review of the inventive apparatuses, systems and methods illustrated and discussed herein.

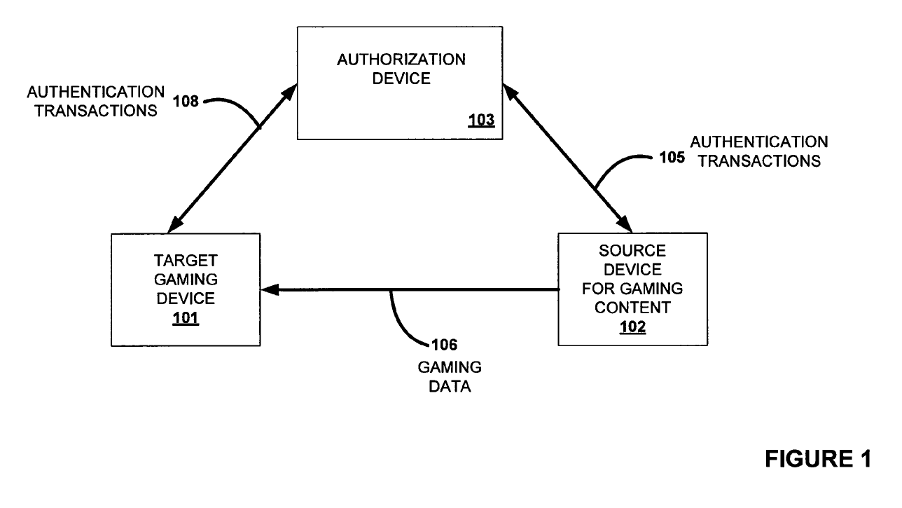

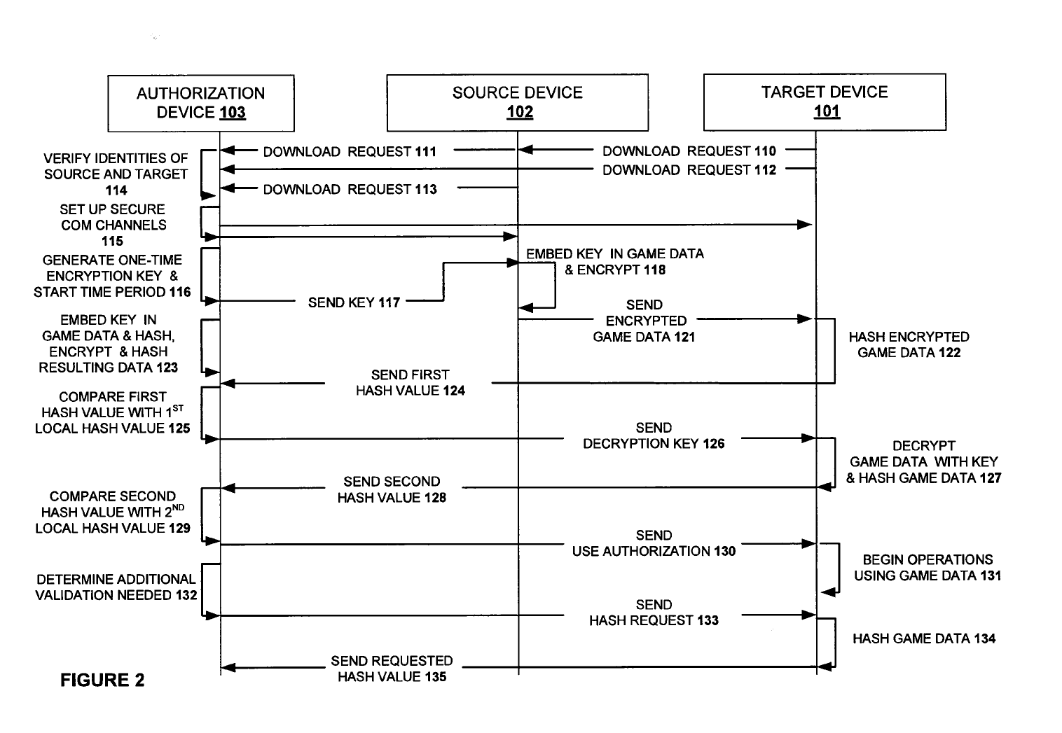

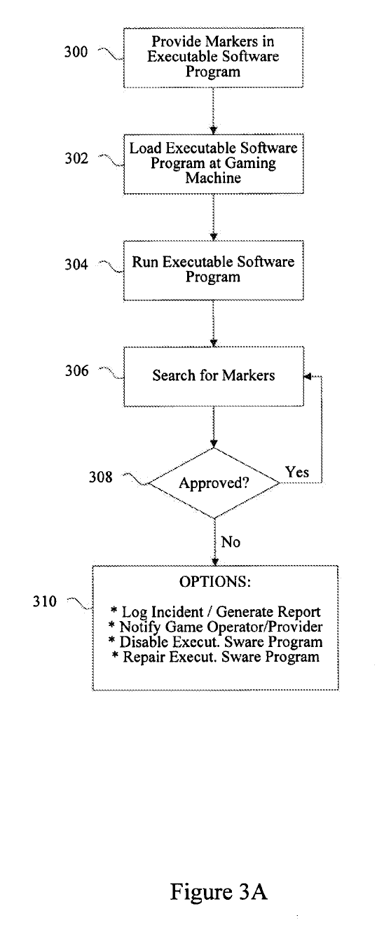

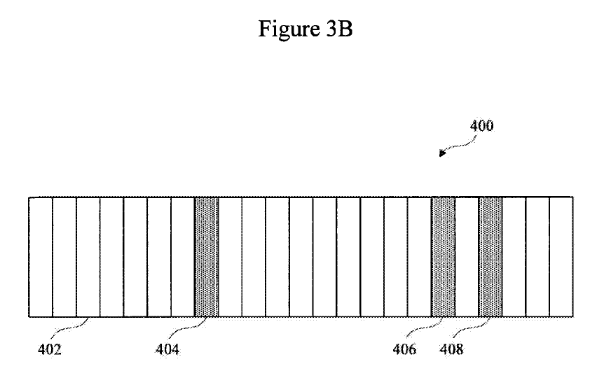

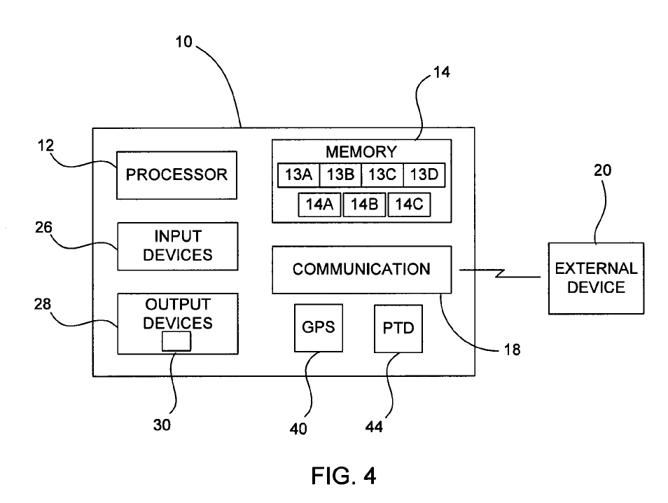

In FIG. 1, a gaming system that allows a transfer of gaming data between a first gaming device and a second gaming device under the control of a third gaming device is illustrated. Details of a methodology for enabling a secure download of the gaming data is described with respect to FIG. 2. In FIGS. 3A and 3B, additional methods for improving security and preventing tampering of gaming software are described. In FIGS. 4-7, hardware and software components that may be utilized in gaming system of the present invention are described.

FIG. 1 illustrates a block diagram of a gaming system in one embodiment of the present invention. The gaming system comprises an authorization device 103, a target gaming device 101 and a source device 102. The source device 102 includes gaming content that may be transferred as gaming data 106 to the target gaming device 101.

In one embodiment, the authorization device 103 may be configured to perform a number of transactions, such as authentication transactions 105 and 108. The authorization device 103 may use the transactions to control the download of the gaming data from the source device 102 to the target device 101. Details of the download methodology utilized in the gaming system are described with respect to FIGS. 2-3B.

The authorization device 103, the target device 101 and the source device 102 may be in communication via a network. In one embodiment, the authorization device 103 may be in a secure location separate from the source device 102. The secure location may be on-site at a casino or a totally separate location, such as a location controlled by a gaming regulator or other trusted entity. In one embodiment, the authorization device 103 may not be allowed to receive or process any of the gaming content that is sent to the target device 101. An advantage of separating the authorization functions of 103 from the gaming content providing functions of 102 is that an attack on one of the devices may not compromise the other device. Hence, distributing the functionality between devices may make it more difficult to mount a successful attack.

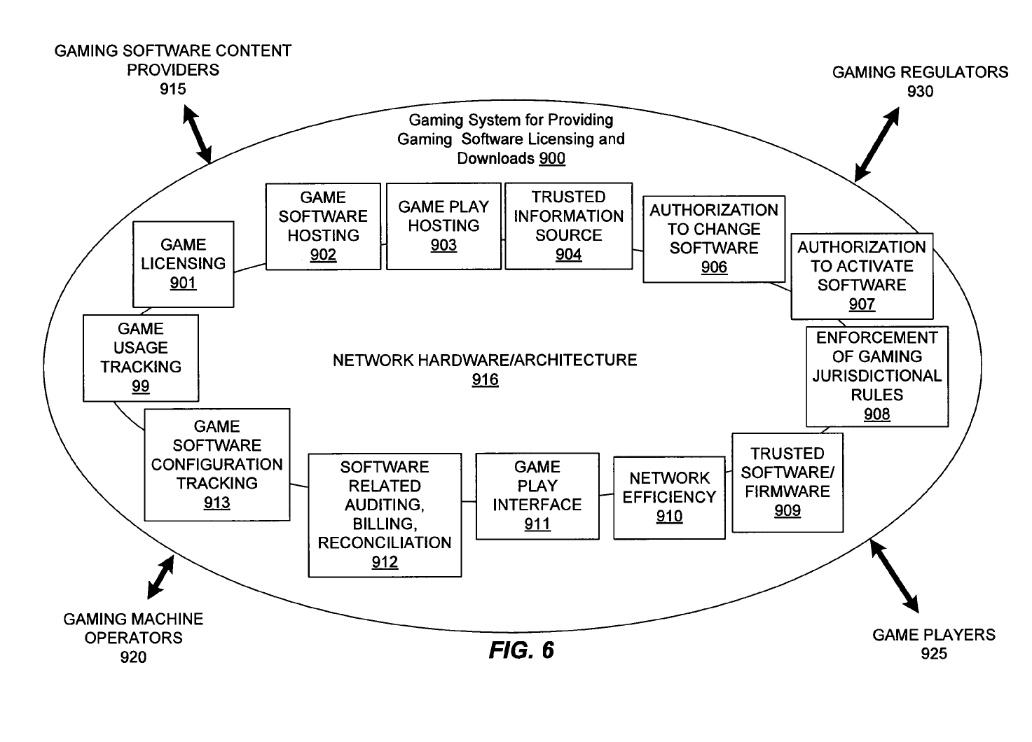

FIG. 2 is an interaction diagram between a source device 102, a target device 101 and an authorization device 103 for one embodiment of the present invention. Interactions between the source device 102, the target device 101 and the authorization device 103 are used to illustrate an example of a secure system for data and software distribution. Additional examples of authorization devices, source devices, target devices and system configurations are described in more detail with respect to FIGS. 4, 5, 6 and 7. The system is not limited to only interaction between three devices. For instance, in one embodiment, the authorization device 103 and source device may be embodied as a single device. In other embodiments, such as shown with respect to FIG. 6, a system may include interactions between more than three devices.

In 110, 111, 112, 113, a download requests messages are shown that request a download of gaming data from the source device 102 to the target device 101. The gaming data may comprise one or more compiled executable images, uncompiled code, video files, sound files, pay tables, operating system data, game history information, firmware, software or any other type of data stored on the target device 101. The multiple sources for the download requests, 110, 111, 112 and 113 are provided to illustrate that the download request may be initiated from a variety of sources and may be sent directly or through one or more intermediary devices. For instance, the download request may be initiated at a) the target device 101 and then sent directly or via the source device 102 to the authorization device 103, b) at the source device 102 and sent directly to the authorization device 103, c) at the authorization device 103, gaming server (not shown), approved gaming control device, or at another gaming device (not shown). Also, the download request may be sent to the source device 102.

The system may allow an operator, a player or a regulator to manually initiate a download request. Further, the system may allow players, operators or regulators to specify trigger conditions for a download request. The download request may be initiated from the source device 102 or the authorization device 103. For instance, in one embodiment, a download request may be triggered when a request is made to check out a mobile gaming device, which may be a “thin” client. The mobile device may only include RAM, such that, operating software is downloaded to it at least each time it is checked out. In the example of FIG. 2, the mobile gaming device would be the target device 101. Further details of mobile gaming devices are described with respect to FIG. 4.

In general, secure communications are set up between the source device 102, the target device 101 and the authorization device 103. As part of the communication set-up, one or more of the target device 101, the source device 102 or the authorization device 103 may identify the other devices to which it will communicate. Each of 101, 102 and 103 may store information regarding devices that it may engage in communications. For instance, the target device 101 may only talk to the source device 102 and the authorization device 103. The source device 102 may talk to a plurality of target devices but only to the authorization device 103. The authorization device may be operable to communicate with a plurality of source devices and a plurality of target devices.

The download request may include a description of the game data that is requested. After or prior to verifying the identities of the source device 102 and the target device 101, i.e., upon receiving the description of the game data, the authorization device 103, the source 102 or both may check to determine whether the transfer is allowed. The game data that a target device is eligible to receive may vary from target device to target device. For example, a target device that is more secure such as a stand-alone gaming machine with money handling capabilities may be allowed to receive more types of game data than a mobile gaming device. In addition, the game data that a source device is allowed to transfer may vary from source device to source device. For example, not all source devices may be allowed to transfer game data related to money handling or game outcome generation. When either the source device 102 or the target 101 is not eligible for the download request, the download request may be rejected and information regarding the rejected request may be stored.

In one embodiment, in 114, the authorization device 103 verifies the identities of the source device 102 and the target device 101. The authorization device 103 may also attempt to verify the location of the device and compare with a stored location associated with the device. Geolocation software may be used to deduce the geolocation (geographic location) of the other party, for example on the internet. One simple approach to geolocation is looking at the IP address and determining what country, organization, or user it has been assigned to, and guessing the user's location based on that. Other means include examination of a MAC address, image metadata, global positioning system (GPS) data or credit card information. When identities (and possibly the locations) of the source device 102 and target device 101 are verified, then in 114, secure channels may be set-up between the authorization device 103 and the source device 102, the authorization device 103 and the target device 101 and the source device 102 and the target device. These secure channels don't necessarily all have to be set-up at the same time and may be set-up as communications are needed.

In another embodiment, the source device 102 may receive the download request, such as in 110. After verifying the identity of the authorization device 103 and target device 101, the source device 102 may open secure channels using SSL, TLS, SSH, or a comparably secure encrypted means to the target device 101 and the authentication device 103. Next, the source device 102 may issue a request to the authentication device 103 to generate a one-time asymmetrical encryption/decryption key pair for the transfer. After verifying the identity of the target device 101, the authentication device may then open a secure channel to the target device 101 comparable to that described above, i.e., a channel using SSL, SSH or comparable security protocol.

In 116, the encryption key generated as part of the asymmetrical encryption/decryption key pair typically includes a random component. An expiration time or period may be placed on the encryption key, such that the authorization device 103 may allow a use of the key for a limited time period. After the key is generated authorization device 103 may store a record of the game data transaction including but not limited to information regarding the source device, the target device, a time the transaction is initiated, etc.

More than one expiration time may be specified for the encryption key. For example, a first expiration time may be specified during which time an initial transfer of the game data is to be completed. When the initial transfer of the game data is not completed prior to the expiration time, then the authorization device may not send an authorization message to the target device 101 indicating that the target device is allowed to utilize the downloaded game data.

In 117, the authentication device 103 transmits the encryption key (comparable to a public key in PKI methods) to the source device 102. When the source device 102 receives the encryption key from authentication device 103, it may embed the encryption key into the game data in a designated location. For instance, when the game data includes binary data, such as binary code, the encryption key may be embedded using binary patching technology or other methods known in the art.

The encryption key may be embedded into the game data file in such as way as not to affect its execution or other use by the target gaming device. For example, it may be embedded at the end of the file. The game data file may also be created with several non-executable blocks within its file structure, and the encryption key may embedded into any one or several of those locations, which may be selected randomly. As the embedded encryption key will never need to be retrieved from the game data file, its location in the file is irrelevant to the target gaming device. Its sole purpose it to introduce sufficient randomness to the game data file so that the calculated hash value, or the result of another one-way function applied to the game data file, is unique to that combination of game data, encryption key, and embedded location.

After the key is embedded, in 118, the source device 102 may encrypt, using the encryption key, the game data including the encryption key. In another embodiment, only a portion of the encryption key may be embedded in the file and then the game data may be encrypted using the encryption key. In a further embodiment, the hash of the encryption key, or the result obtained from applying another one-way function to all or a portion of the encryption key, may be embedded in the file and then the game data may be encrypted using the encryption key. In yet another embodiment, random data separate from the encryption key may be received from the authentication device, embedded in the game data and then the game data may be encrypted using the encryption key.

After the game data with the embedded key is encrypted, the source device 102 may discard the encryption key. The encryption key that is embedded in the game data may be used only once (and is not reused) and a new encryption key may be generated each time the game data is transferred. Thus, each time a particular set of game data is transferred, a hash value or other one way function value generated from the game data with the embedded encryption key is different for each transfer of the particular set of game data. In the embodiment of FIG. 2, the source device 102 doesn't generate a hash value or other one way function associated with game data.

An interceptor of the game data may not gain access to the embedded encryption key unless and until the game data is decrypted. By embedding the encryption key in the game data, an element of randomness may be added that results in a unique hash value for the game data. Using the encryption key in this manner is not likely to compromise security and eliminates the step of transmitting an additional random string between the source device 102 and the authentication device 103. Further, when only a portion of the encryption key, the hash or a result of another one-way function applied to all or a portion of the encryption key is embedded in the game data, then the actual encryption key is never revealed once the file is later decrypted.

In 123, the authentication device performs, the same embedding operation as the source device 120 performs, with a local, identical copy of the game data that is to be transferred from the source device 102 to the target device 101 using the encryption key it generated in 116. These operations may occur while the source device is embedding the encryption key and encrypting the game data in 118 or sending the encrypted game to the target device in 121.

Upon competing the embedding operation, in 123, the authorization device may generate a first hash value of the program using a first hash algorithm, then may encrypt the game data using the encryption key, and then may compute the hash of the encrypted game data using a second hash algorithm. The authentication device may retain these two hash values but may then discard the encrypted program as superfluous.

The entire game data or the encrypted game data does not have to be hashed. The authorization device may be operable to select one or more portions of the game data or the encrypted game data for which to generate a hash value. The authorization device 103 may send instructions to the target device indicating one or more portions to hash and what algorithms to use for each portion.

The first and second hash algorithms may be the same. Further, the hash algorithms may change with time or from download to download. In one embodiment, the authorization device may determine hash algorithms to use at random. Then, the target device 101 may be sent the algorithms to use by authorization device. This message may be sent prior to, during or after the target device 101 receives the encrypted game data in 121. The source device 102 may not store any information in regards to what hash values are to be used.

When the target device 101 receives the game data from source device 102, in 122, the target device 101 may calculate the hash of the encrypted game data that it has received using a designated hash algorithm. In 124, the target device 101 may transmit a message including the hash value it has generated to the authorization device 103 via the secure channel. In general, secure channel denotes that some effort is made to protect the communications over the channel, such as via use of encryption, use of certificates, use of a dedicated line, etc.

In 125, the authorization device 103 may compare the hash value received from the target device 101 with the reference hash value it computed after embedding and encryption operations in 123. In 126, when the hashes match, the authorization device 103 may transmit the decryption key (comparable to a private key in PKI methods) to the target device 101 via the secure channel. The authorization device 103 may also check whether the time allocated for the transaction has expired.

When the hashes do not match or the time allocated has for the transaction has expired, the authorization device 103 may generate appropriate “tilt” conditions, logging events, and/or operator notifications and the download request may be terminated. In one embodiment, the authorization device 103 may restart the download request by generating a new set of encryption keys in 116.

In one embodiment, when the hashes don't match, the authorization device 103 may request the source device to hash one or more of the game data, the encryption key, the game data embedded with the encryption key and the encrypted game data embedded with the encryption key or combinations thereof. The hash algorithm may be the same algorithm or a different algorithm than the hash algorithm used by the target device 101. An advantage of using a different hash algorithm on the source device 102 as opposed to the target device 101 is that the source device 102 will not be capable of generating the same hash values that the target device 101 generates during a download request, which may result in a more secure system.

After receiving any requested hash values from the source device 102, the authorization device may compare it with hash values it has generated locally to determine sources that may have caused the failed download request. For example, if the hash of the encryption key is incorrect and the hash of the game data is correct, it may be possible that an error occurred during the transfer or storage of the encryption key. When the hash of the game data is incorrect, it may be possible that the game data has been corrupted and the authorization device 103 may send a message to an operator indicating that additional investigation including replacing the game data at the source device 102 may be warranted.

In yet another embodiment, when the hashes do not match the authorization device 103 may request game data from the source device 102, the target device 101 or both devices in the case when the hashes don't match. For example, the authorization device 103 may initiate a transfer of one or more of a) encrypted the gaming data the source device 102 indicated it sent to the target device, b) the unencrypted gaming data stored on the source, c) the encryption key received from the authorization device or combinations thereof. Further, the authorization device 103 may request a) a transfer the encrypted game data received at the target device 101 from the source device, b) the decryption key received from the authorization device, c) the decrypted game data or combinations thereof. The transfer of data may be from the target device 101 and/or the source device to the authorization device 103 or another remote gaming device. For instance, the remote gaming device may be isolated from the system/network including the authorization device 103, source device 102 and target device 101.

The transferred data may be used to determine possible sources of errors including whether tampering was involved and when it might have occurred. For example, when the game data and encrypted game data appear to be correct on source device 102 but incorrect on the target device 101, then transmission of data between the devices may be further investigated and the data on the target device 101 may be further investigated. When it is determined that an attempt at tampering has occurred, preserving the game data on the source device 102 or the target device 101 may be helpful in trying to determine the nature of the tampering that was attempted.

Returning to FIG. 2, in 125, when the authorization device 103 determines that the hash value it generated (1^{st} local hash value in FIG. 2) and the hash value (first hash value in FIG. 2) received from the target device 101 match, then in 126, the decryption key may be transmitted to the target device 101 via the secure channel. In 127, the target device may use the decryption key to decrypt the game data. Upon completion of the decryption, the target device 101 may compute the hash of the decrypted game data using the same or a different hash algorithm as used in 122. In 128, the target device 101 may transmit the second hash value it has generated to the authorization device 103.

In 129, the authorization device 103 may compare the received hash (second hash value in FIG. 2) with the reference hash it computed (2^{nd} local hash value) after embedding the encryption key in the game data but prior to encryption. When it is determined the hashes match, the authorization device 103 may transmit an authorization message to the target device via the secure channel, which enables or authorizes the target device 101 to utilize the game data in its operations. For example, when the game data comprises all or a portion of a game program, the target device 101 may be configured not to load and execute the decrypted game program until it has received an authorization message from the authorization device 103. When the hashes do not match, the authorization device 103 may generate appropriate “tilt” conditions, logging events, and/or operator notifications and other remedial actions as was described with respect to 125.

In one embodiment, the encryption key may be embedded in the game data, such that the game data is not usable or possibly generates bad results unless the encryption key is extracted from the game data. The target device 101 may not have knowledge of where the encryption key is located in the game data. Thus, in 130, the use authorization message may also include information that allows the target device 101 to extract the encryption key or any other data that has been embedded in the game data.

In 131, after receiving an authorization message, the target device 101 may begin operations using the game data. For example, when the game data includes all or a portion of a program, such as an executable image, for generating a game, the target device 101 may load and execute the program. As another example, when the game data includes all or a portion of a program for a peripheral device coupled to the target device, the game data may be transferred to the peripheral device for execution.

The target device may also include logic that limits an amount of time for completing the download and/or authorization transaction. Thus, after a start of component in the download process, such as initially receiving game data in a download, sending a hash value to the authorization device the first time or the second time, etc, the target device 101 may start monitoring a time. When a reply is not received from the authorization device within a set time period, the target device may take remedial action. For instance, when an authorization message is not received within a set time period from initiating the download, in one embodiment, the target device may be operable to delete any game data it has received and notify an operator. Other remedial actions it may take are described with respect to 125, such as entering a tilt state.

At any interval desired by the system operator, the target device 101 may be commanded to compute one or more hashes of all or portion of programming executing in volatile memory and/or stored on the target device and transmit said hash or hashes to the authorization device 103 for continuing validation. In 132, the authorization device 103 may determine that a validation is needed. In 133, the authorization device may send the hash request to the target device. The hash request may comprise all or a portion of game data to hash, memory locations to hash, memory devices to hash, hash algorithms to use or combinations thereof. Thus, the generated hash may or may not be the same hash value that has been previously generated.

In 134, the target device may generate the requested hash value according to information received from the authorization device 103. In 135, the target device may send a message including the hash value to the authorization device 103. The authorization device 103 may evaluate the hash value and determine whether to reauthorize the target device 101 for continuing operations. The reauthorization may involve sending a message to the target device 101 with information indicating it is to continue operations.

In other embodiments, the target device may calculate the hash at some interval and send it to the authorization device 103 without receiving a command from the authorization device 103, such as in response to certain events generated on the target device 101. For example, when the target device 101 awards a jackpot over a certain value, the target device 101 may be operable to establish communications with the authorization device 103 and send a hash value to the authorization device for validation. In this embodiment, the target device 101 may not display an award until it receives an approval from the authorization device 103. In general, when the target device 101 sends a hash to the authorization device 103 (at its own initiation or in response to a command from the authorization device 103 or another device), the target device 103 may suspend operations and take remedial action when it does not receive a reauthorization from the authorization device 103.

At any interval desired by the system operator, the source device 102 may be commanded to initiate a software reload by repeating the process described with respect to FIG. 2. New encryption and decryption keys may be generated for each such download, and the act of embedding the encryption key and/or other data in the program may insure that the hash of the downloaded program is unique. An advantage of this approach may be that any attempted attack using information gleaned from all previous downloading operation, such as a previously calculated hash value, are not useful.

Next, additional methods and apparatus are described that may be used to prevent tampering and to insure that authenticated casino gaming software and game data are utilized. The method and apparatus may be also used to make it more difficult to ascertain functional elements of the code if an executable image of the game code is acquired by an unauthorized entity. The additional methods may be compatible with and may be used in conjunction with the authentication method described with respect to FIGS. 1 and 2 or the methods may be used independently of the methods and apparatus described with respect to FIGS. 1 and 2.

In one embodiment, an encryption wrapper may be used. In an encryption wrapper, all or a portion of gaming software and gaming data may be in an encrypted format while stored in memory. The encryption wrapper may be configured such that a portion of an encrypted executable is decrypted just before it is executed in such a manner that the entire decrypted executable is never in memory at the same time. In a particular embodiment, the executable image may be compressed and then encrypted when it is stored.

In another embodiment, gaming software may be obfuscated in some manner to prevent reverse engineering and tampering. For example, all or portion of the named variables in the gaming software may be replaced with a random string of alphanumeric characters. Typically, programmers give their variables names that are related to their functionality. By replacing the name variables with random strings of alphanumeric characters it may be much more difficult to decipher the functionality of game software. Obfuscation may delay an amount of time it takes to reverse engineer gaming software.

In yet another embodiment, markers may be used to create a unique signature for the gaming software. A security marker may be data, such as a variable length word or a sequence of coding instructions, inserted into gaming software that allows different copies of the same gaming software to be customized with a unique signature. The coding instructions and/or game data may be non-functional such that they don't interfere with the normal operation of gaming software and yet may appear to be part of the gaming software. In FIG. 2, data in the form of an encryption key was inserted into the game data, which may include gaming software, to create a unique signature (e.g., hash value) for the game data.

Many different types of security markers are possible and gaming software may be marked using combinations of types of security markers that vary from copy to copy of gaming software. For example, gaming software may include a combination additional data inserted at different locations and/or executable code inserted at different locations. In each copy of the gaming software, a number of security markers may be inserted at different locations in the software. Thus, the number, placement and type of the security markers may be varied from copy to copy, such that their use appears “random” to a person examining a number of copies of the game software. The security markers may be inserted in the pre-compiled source code or directly into a compiled binary.

In yet another embodiment, gaming software may be self-checking. Self-checking gaming software may include one or more embedded checkers that checks the gaming software as it is executed on the gaming machine. A checker may refer to a sequence of software instructions that checks a property of game code. The checkers may be implemented such that execution of the compiled gaming software executes the checkers. The checkers may be executed multiple times while the gaming software is in RAM. For example, each time a game of chance is played on a gaming machine, the executable for the game of chance may check itself when one of its embedded checkers are triggered.

In a particular embodiment, one or more checkers may check a configuration of security markers in a piece of gaming software, such as the location of each security marker in the game software. The one or more checkers may use security marker configuration information generated when the security markers are placed in the gaming software. In another embodiment, each of the checkers may generate a hash value for all or a portion of the gaming software executable. In general, the checkers may be used to check any definable property of the gaming software executable.

The checkers may be invoked at different points during run-time and may be game event dependent. For example, a checker embedded in a bonus portion of the game software may only be executed when a bonus sequence is triggered during game play. As another example, a particular checker in a slot game may be randomly invoked, such as when one or more symbol combinations appear or a random number generated for the symbol combinations is within a certain range.

In a particular embodiment, a group of checkers may be designed to function dependently. For example, a group of checkers may be designed to calculate hash values over overlapping ranges of an executable image. Thus, if a checker or some other portion of the code is modified in one location of the executable, another checker may detect this modification when it calculates its hash value. Thus, an attacker trying to circumvent the checkers may be required to disable most or all of the checkers to avoid detection.

When a group of checkers is used it may be desirable to configure the checkers so that they do not give away one another. In the example describe above, the checkers do not have to know anything about any other checkers to perform their calculations. Thus, information used by one of the checkers to generate their hash value and the information generated in the hash calculation does not lead to another checker.

Checkers with identical functions may be made more difficult to recognize by coding their functions using different combinations of coding instructions that perform the same task. Thus, if one checker is identified, one may not be able to find the other checkers by scanning for similar sequences of code. Further, dummy checkers may be inserted into the gaming software that appear to look like a checker and yet don't perform any function.

To make it more difficult to find a checker, a read of information by the checker may be obfuscating read instructions, such as via using complex addressing modes, so that code section addresses targeted by the reads are never in single registers. A vulnerability of checkers is that they load bytes from the code, which normal code typically doesn't do. The checker may be configured such that code-section addresses never appear in any general purpose register during the calculations performed by the checker, such as the calculation of a hash value. Thus, if a person trying to locate the checkers uses a sampling attack, in which contents of the registers and the stack are monitored for suspicious values, such as code section addresses, the sampling attack will not reveal the code sampling addresses.

The checkers may be inserted at the binary level after the gaming software is developed and compiled so that it doesn't interfere with the gaming software development or the functionality of the gaming software. In one embodiment, each copy of gaming software may be implemented with its own combination of checkers. An advantage of this approach, when it is demonstrated that the checkers never interfere with the gaming functionality is that the binary gaming software may be approved for use on a gaming device and then each copy may be seeded with different combinations of checkers without obtaining additional approval for each version of the gaming software utilizing a different combination of checkers.

With reference to FIG. 3A, shown is a flow diagram of an exemplary process for verifying the integrity of an executable software program according to one embodiment of the present. The executable software program can include program instructions for presenting a game of chance. At 300, static security markers can be provided in the executable software program. These security markers can be placed within the software at locations and in formats that can be checked during execution of the software program. More particularly, the security markers can be placed such that alteration of the executable software program alters the content, placement, or content and placement of the security markers. Accordingly, the executable software program can be authenticated if it is found that the security markers have not been altered.

Referring to FIG. 3B, shown is a diagrammatic representation of one embodiment of an executable software program that includes security markers. The executable software program 400 includes instruction sequences 402 and security markers 404, 406, and 408. The instruction sequences 402 can be instructions, one or more bits, or the like. Furthermore, the security markers 404, 406, and 408 can be instruction sequences inserted between existing instruction sequences that are part of the executable software program. These security markers can be designed such that they are transparent with respect to the functionality of the executable software program. In other words, the security markers are not functional to the game of chance provided to a gaming machine or other gaming device, but the security markers can be detected to determine whether they have been modified, moved, etc. If the security markers are modified, moved, etc., then it can be determined that the executable software program has been tampered with, has become corrupt, or the like. One example of a product that can be used to provide such security markers in an executable software program is called EnforcIT, available from ArXan Technologies (San Francisco, Calif.).

Returning to FIG. 3A of the present embodiment, once the security markers are provided in the executable software program, the executable software program can be loaded onto a gaming machine. See operation 302. Next, the executable software program can be run at the gaming machine. See operation 304. During execution of the executable software program, the executable software program can be authenticated. More particularly, the executable software program can be searched for security markers. See operation 306. Next, it can be determined whether the security markers are approved. Specifically, if the content, placement, etc. of the security markers has been altered, then the executable software program can be deemed not approved. Once it is determined that an executable software program is approved, then the executable software program can continue to run. In this manner, the security markers can be checked periodically, according to a schedule, or the like, depending on the particular application.

If it is determined that an executable software program is not approved, various options can be pursued. See operation 310. For instance, the executable software program can be disabled if it is not approved. In other examples, a game operator can be notified if the executable software program is not approved. The game operator can be a gaming establishment, a remote game provider, an attendant, or the like. In yet other examples, if a non-approved executable software program is found to be damaged, the damaged portion of the executable software program can be repaired. In other instances, an entry on a log can be generated if the executable software program is not approved.

FIG. 4 is a block diagram of a gaming device 10, in accordance with one embodiment of the present invention. As used herein, gaming device 10 refers to any device associated with game play including for example receiving credit, inputting data into a game, processing the results of the game, outputting both the game and the results of the game, recording the results of the game, monitoring the game, paying out the game, and the like. The gaming device 10 may for example be a gaming machine, a handheld portable game player, a ticket validation device, and/or the like.

The gaming device 10 may include a processor or controller 12 that carries out operations associated with the gaming device 10. The processor 12 operates to execute code and produce and use data. The code and data 13 may for example include log files 13A, operating systems 13B, communication code 13C, gaming code and data 13D, and the like.

The code and data 13 may reside within memory block 14 that is operatively coupled to the processor 12. The memory block 14 generally provides a place to hold data and code that is being used by the gaming device 10. The memory block 14 may include one or more memory components including non-volatile memory components 14A such as ROM or flash memory, volatile memory components 14B such as RAM (in any of its various forms), and/or a hard drive 14C. The memory block 14 may also include removable media 14D such as CDs, DVDs, floppy's, flash memory, portable hard-drives, magnetic tape, etc. The memory block 14 may also include memory components located over a network, such as a remotely mounted memory via the network.

The gaming code or data 13D may include the gaming logic for controlling a game played on the portable device. The gaming code may comprise executable coding instructions and game data for generating a game presented on the device. For instance, the gaming logic may comprise all or a portion of the logic for a) determining financials (whether a win or loss, amount of win, random numbers), b) communicating with a remote host, c) receiving game inputs, d) presenting the game on a display mechanism, e) controlling devices (e.g., device drivers), f) determining security conditions and responses (e.g., tilt conditions resulting from device tampering, out of range, off-limit area), g) loading and unloading executables (e.g., an operating system), etc. The game data may comprise pay table data, pay out data, such as winning and losing outcomes and their associated awards, video files, audio files, used to present the game.

In addition, the gaming data and/or code 13D may also include logic for maintaining a gaming state during game play, preserving a game history (information relating to games played on the device and device status information during the play of the games). The gaming state and game history may be stored as data in the memory 14. The gaming data or code 13D may also include non gaming logic such as code for performing outputs and receiving inputs associated with the game being played (e.g., the code used to display the game and the results of the game).

All or a portion of the gaming code and data 13D may be stored in one or more of these memory components 14A-D. For example, the gaming code and data 13D may be stored entirely in one memory component such as hard drive 14C, RAM 14B or flash memory 14A. Alternatively, the gaming code and data 13 may be spread across multiple memory components 14. For example, a first portion may be stored in a first memory component, and a second portion may be stored in a second memory component. Additionally, a third portion may be stored in a third memory component and so on.

In one particular embodiment, the gaming code and data 13 is stored on the hard drive 14C. In fact, the hard drive 14C may be partitioned into multiple partitions where the operating system 13B resides on one partition, the gaming data and code 13D including for example executable files, binaries and resources, reside on another partition, a third partition serves as a place for writing log entries 13A, and a fourth partition contains communication code 13C designed to maintain contact with external systems such as peripherals, hosts, servers, etc. While residing in memory, such as the hard drive 14C, the data may be stored in an encrypted or unencrypted format. When stored in an encrypted format, executable code or game data may be decrypted prior to execution on the device 10.

In another particular embodiment, the gaming code and data 13 is stored in RAM 14B, i.e., a volatile memory. The gaming code and data 13 can also be stored in an erasable non-volatile memory. For example, the hard drive 14C may contain the operating system 13B, log files 13A and communication code 13C, and the gaming data and code 13D may be downloaded from a server system at run time and stored in volatile memory.

In yet another particular embodiment, various portions of gaming code and data 13D is stored in both the hard drive 14C and RAM 14B. For example, a first portion of the gaming code and data 13D may be stored in the hard drive 14C, and a second portion of the gaming code and data 13D may be stored in RAM 14B.

The gaming device 10 also includes a communication interface 18 that is operatively coupled to the processor 12. The communication interface 18 provides a means to communicate with a external devices 20 such as server systems, peripherals, hosts, and/or the like via a data link 22 provided over a wired or wireless connection. The communication interface 18 may for example utilize the communication code 13C stored in memory 14. In the case of a wireless connection, the communication interface 18 may include a transceiver and an antenna. Also, the communication interface 18 can use various wireless communication protocols including for example IEEE 802.11a, IEEE 802.11b, IEEE 802.11x, hyperlan/2, Bluetooth, HomeRF, etc.

The gaming device 10 also includes one or more input devices 26 that are operatively coupled to the processor 12. The input devices 26 allow a user to interact with the gaming device 10. For example, they allow a user to input data into the gaming device 10. The input devices 26 may take a variety of forms including for example buttons, switches, wheels, dials, keys, keypads, navigation pads, joysticks, levers, touch screens, touch pads, microphone, mouse, trackball, bill receptors, cameras, biometric input devices (i.e., finger printer readers), wireless interface (e.g., for communicating with an RFID tag or wireless transceiver), etc.

The gaming device 10 also includes one or more output devices 28 that are operatively coupled to the processor 12. The output devices 28 allow the gaming device 10 to interact with the user. For example, they allow the gaming device to output data associated with the game to the user. The output devices 28 may take a variety of forms including for example a display, speakers (or headset), indicator lights, display lights, printers, etc.

At the very least, the gaming device 10 typically includes a display 30 such as a CRT display or LCD display for displaying a graphical user interface GUI. The GUI provides an easy to use interface between a user of the gaming device 10 and the operating system or applications (e.g., games) running thereon. Generally speaking, the GUI represents, programs, files and various selectable options with graphical images. The GUI can additionally or alternatively display information, such as non interactive text and graphics, for the user of the gaming device. In the case of a gaming machine or game player, the GUI may include the various features of the game being played thereon.

The configuration of input and output devices 26 and 28 may vary according to the type of gaming device 10, and if a gaming machine or game player, the game or games being played thereon. Each game may have a set of dedicated inputs and outputs or multiple games may utilize the same inputs and outputs.

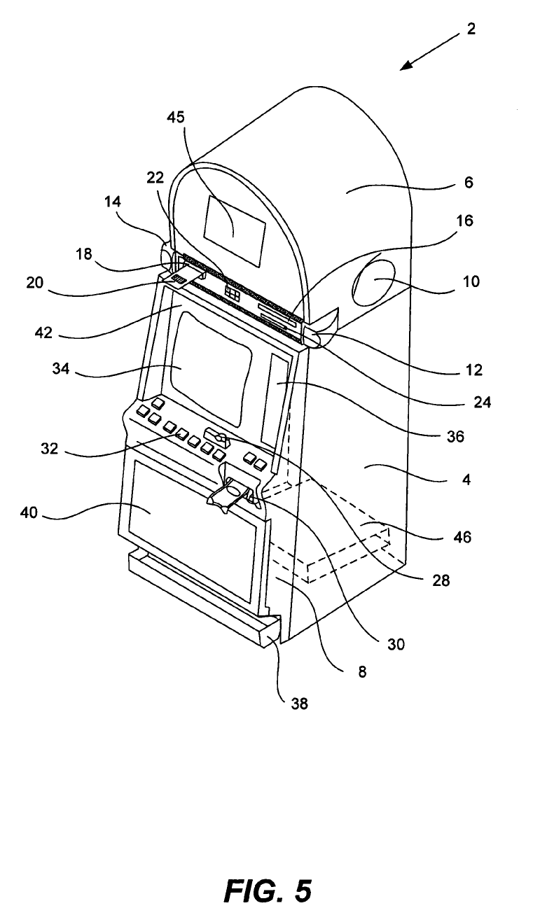

As mentioned above, the gaming device 10 can be widely varied. In one embodiment, the gaming device 10 is embodied as a gaming machine. In cases such as this, typically all the gaming data and code 13D is stored on memory 14 in the gaming device 10. An example of a casino type gaming machine is described with respect to FIG. 5. Although FIG. 5 illustrates a large non-portable gaming machine, all or a portion of the functions and devices described with respect to the gaming machine may be adapted to the hand held game players of the present invention.

In another embodiment, the gaming device 10 is embodied as a handheld game player. In most cases, the handheld game player is in communication with a server system 20 such as a gaming machine or gaming server via a wireless network (such that the handheld game player is an extension of the gaming machine or gaming server). More examples of the server system are described with respect to FIG. 6. The gaming machine or gaming server 20 typically includes the gaming logic and gaming history of the gaming data or code 13D while the handheld game player includes the I/O aspects of the gaming code and data 13D. That is, the handheld game player is a remote I/O terminal that a user carries around to physically play a game remotely or away from the location where the game is actually being played electronically (server system). It should be noted however that this is not a limitation and that in some circumstances the handheld game player may include some or all aspects of the gaming logic and/or gaming history.

Alternatively, the gaming device 10 may be embodied as a peripheral gaming device such as a ticket validation device.

Examples of gaming machines and game players can be found in U.S. Pat. No. 6,846,238, which is herein incorporated by reference.

In order to secure the gaming code and data (hereafter “gaming data”) on the gaming device 10, the gaming device 10 includes one or more security triggers that indicate when the gaming device 10 can no longer be trusted or when the gaming device 10 has been compromised. In some cases, single triggers are used. In other cases, multiple triggers are used. The gaming device 10 also includes one or more security measures that are implemented in accordance with a security triggering event. In some cases, only one security measure is implemented. In other cases, multiple security measures are implemented. The security triggers and measures may be implemented through software, hardware and/or firmware.

Various sensors may be employed with the gaming device 10. Examples include optical sensors, magnetic sensors, and mechanical sensors. The sensors may be active or passive. An example of a passive sensor may be a light-sensitive patch on the back of a battery or circuit board, such that when it is exposed to light it changes color. Another example of a passive sensor is evidence tape. Passive sensors may be checked when a security event or other important event occurs on the hand-held device, such as a win of a jackpot. An example of an active sensor may comprise a light switch that is monitored by a logic device on the gaming device 10. A circuit including the light switch may be altered when an access mechanism on the device is actuated.

Various access mechanisms may be employed with the gaming device. Examples include locks, wires, retaining latches and device receptors. Depending upon the type of access mechanism employed, the access mechanism may be actuated by opening a door, unengaging a lock, accessing a signal path on wire, opening a retaining latch, or emptying a device receptor. The sensors and/or access mechanisms may be configured in a manner to trigger a security event when the gaming device is improperly accessed. For example, a memory removed from a memory receptacle in the device 10 may trigger a security event in one embodiment of the present invention.

In accordance with one embodiment, the security measures include at least immediately removing at least select portions of the gaming data or code 13D from the memory 14 of the gaming device 10 when a security triggering event occurs. For example, the select portions of the gaming data or code 13D may be erased or wiped from memory 14 such as hard drive and/or RAM. This may for example be accomplished with anti tampering code stored on the gaming device 10 that is executed once a determination is made that the gaming device 10 is no longer a trusted device. The select gaming data may be the entire set of gaming data or code 13D stored on the gaming device 10 or portions of the gaming data or code 13D with the greatest protection needs (e.g., anything involved with generating gaming results or financials). The select gaming data or code 13D may include for example executable code, binaries, resources that are associated with operating the gaming device 10.

Many methods may be used for determining whether the gaming device 10 is a trusted device. In one embodiment, the gaming device 10 is persistently connected to a server system 20 through a wired or wireless connection. The server system 20 may be a gaming server, gaming machine that acts like a server to the gaming device 10, an oversight server and/or the like. An oversight server may be a server that provides oversight or monitoring functions.

At various intervals, the gaming device 10 sends a heart beat message to the server system 20. The heart beat message indicates that the gaming device 10 is online. The server system 20 responds with an acknowledgement message that the heart beat has been received. In this way, both the server system 20 and the gaming device 10 are aware the gaming device 10 is connected to the server system 20 and thus the gaming device 10 is trusted (i.e., it has not been removed from the overall gaming system or environment).

However, if a heart beat message is not received at the server system 20, the server system 20 assumes that the gaming device 10 has been compromised (no longer a trusted device). At this time, the server system 20 may raise a security alert or alarm. This allows an operator to know immediately when the gaming device 10 has been compromised.

Additionally or alternatively, if an acknowledgment message is not received at the gaming device 10, the gaming device 10 itself assumes that it may have been compromised (no longer a trusted device). At this time, the gaming device 10 wipes the select gaming data or code 13D from memory 14. For example, it erases the executable files, binaries and resources associated with gaming operations from the hard drive and/or RAM. In some cases, the gaming device 10 may even wipe other portions including all portions associated with gaming as well as log files, operating systems and/or communication kernels. This may be referred to as a self destruct. The gaming device 10 may even enter a security mode that displays a “Please Call Attendant” message on the display screen 30 and stops accepting input from the input devices 26. Alternatively or additionally, other alarms may be provided at the gaming device 10 including audio or visual alarms (e.g., siren, lights).

Because the heart beat message and acknowledgement message may encounter hiccups especially when communicating over a wireless connection, the gaming device 10 may enter a retry step where it resends the heart beat message before wiping the select gaming data or code 13D from memory 14. Resends may be continued until the retry count reaches the maximum retry count (which may be a configuration parameter of the device).

In another embodiment, the gaming device 10 includes a global positioning system (GPS) 40. In this implementation, the GPS 40 is configured to trigger the device compromised procedure (e.g., wiping the select gaming data or code 13D from memory 14) in the event the GPS signal is lost for a period of time and/or the gaming device 10 has moved outside a preconfigured acceptable location. For example, the gaming device 10 could be configured with allowed coordinate for operating the gaming device 10. If the GPS 40 determines that the location of the gaming device 10 is not within a preconfigured tolerance for the expected location, the gaming device 10 compromised procedure is triggered. Additionally or alternatively, the gaming device 10 may send a security alert message to the server system 20 as soon as the gaming device 10 is not within a preconfigured tolerance for the expected location (so long as they are still connected).

In another embodiment, the gaming device 10 includes physical tamper detectors 44. The physical tamper detectors 44 trigger the gaming device compromise procedure when they detect movement of a cabinet door or removable panel of the gaming device 10. By way of example, the physical tamper detectors 44 may include switches or sensors that are activated when the door is opened or the panel is removed. Additionally or alternatively, the gaming device 10 may send a security alert message to the server system 20 as soon as the detectors are activated (so long as they are still connected).

In yet another embodiment, the gaming device may run an integrity check to determine if it is a trusted device. The integrity check may be generated and analyzed at the server. An example of this arrangement may be found in co-pending U.S. patent application Ser. No. 11/520,963, titled, “METHOD OF RANDOMLY AND DYNAMICALLY CHECKING CONFIGURATION INTEGRITY OF A GAMING SYSTEM,” which is herein incorporated by reference.

In yet another embodiment, the gaming device may employ a number of non-volatile memory locations to store identical copies of security information, such as a random bit string. Under one or more conditions, such as, while the gaming device 10 is powered-up or in communication with a remote device (e.g., a remote server), the values of the bits in the register can be set to a randomly generated pattern and the same information, i.e. the values of each bit, can be stored in another non-volatile memory location elsewhere in the gaming device. For example, see the memory locations in FIG. 4.

When a significant security event occurs on the gaming device, the data from one or more the memory locations may be cleared of data or overwritten with new data. For example, one of the memory locations might be cleared when the gaming device detects the battery power is low on the device or the portable device has been taken beyond a designated area. As another example, the memory location may be overwritten with a new random bit string or other security information each time communication is lost with a remote host.

At some point in the operation of the gaming device 10, a logic device on the gaming device or a remote gaming device can compare the information (i.e., the random bit string) stored in a first memory location with the information stored in one or more the other non-volatile memory locations that store the copies of the security information. In particular embodiments, the memory locations may be checked continuously, at regular intervals, random intervals, after particular events (i.e., boot-up) or combinations thereof. When the values in the memory locations are different, then the logic device may assume a security event has occurred.

The memory locations storing security information may be randomly assigned and vary with time. For instance, each time, a portable gaming device 10 is checked out, a remote host or the gaming device 10 may determine the memory locations that are to be used on the gaming device for storing the security data. The memory locations and/or the information stored in the locations may be valid for a limited time period, which may be checked by the gaming device or a remote host. If a new memory location and/or security information for the memory locations is not renewed within the time period, then a security event may be triggered.

The gaming device may include two or more independent mechanisms for clearing data in a security event. For example, the gaming device may include a wireless device, such as an RFID tag, that is designed such that when the gaming device 10 leaves a certain area the data in the RFID tag is altered. To illustrate, initially, a random bit string may be stored in the RFID tag, in a flash memory location on the gaming device 10 and on a remote host. When the device leaves a designated area, the RFID tag location may be cleared by the RFID tag, this clearing mechanism may be done independently of the logic device on the gaming machine that controls the game, i.e., the logic device that controls the game may or may not be able to detect that the gaming device has left the designated area and may not communicate with the RFID tag. However, when the RFID tag is examined and the data in the tag is compared with the data stored in the logic device and/or the remote memory location, it may become evident that the device has left a designated area or at the very least the data in each of the memory locations will not match. Thus, the trust worthiness of the gaming device may be questioned and remedial action taken, such as reinstalling software on the gaming device.

One embodiment of a gaming system will now be described in conjunction with the above. More embodiments are described with respect to FIG. 6. In this embodiment, the gaming system includes a server system (e.g., server system 20) and one or more client systems (e.g., gaming device 10) that communicate via a wired or wireless connection. The server system may communicate with a plurality of different client systems, or alternatively the server system may only communicate with a single client system. The server system may for example correspond to a gaming machine or a gaming server, and the client system may for example correspond to a portable game player.

The client system may be permanently assigned to a server system or alternatively, the client system may go through an enrollment process to get on the network and assigned to a server system For security measures, the enrollment process may be performed each and every time the client device is powered up and checked out. The communication between the server and client typically contains various security measures such as authentication and encryption. Authentication ensures that each device knows that the data is coming from the other device. Encryption ensures that no one was able to peek at the communications.

In order to provide a more secure gaming system, the server system typically contains the gaming logic and gaming history (all the logic for determining financials, whether a win or loss, amount of win, random numbers, etc.), and the client system, which is persistently connected to the server system, contains gaming code stored in writeable memory (e.g., hard drive. RAM, etc.) for performing outputs (e.g., displaying GUI, playing noises, printing, etc.) and receiving inputs associated with the game being played on the server system (e.g., via touch screen, buttons, etc.). Although the client appears to be a thin client, it should be emphasized that it is not as thin as a web page. The client includes some information about the game being played. For example, it has enough gaming code to figure out how to display data about the game, i.e., the reels, spinning reels, stopping reels, etc. As such, the client device needs to be protected.

For security reasons, the server and client are typically in constant communications with one other. If they stop talking to each other (entirely or over some interval), it is believed that something has been compromised and therefore game play is stopped (typically until the integrity of the system can be verified and communications reinstated). By way of example, the client may send out a heart beat message at random or particular intervals. If the server does not receive the heart beat message at its proper interval, the server may decide that something is wrong with the client and the game should be stopped until the problem is identified. The heart beat typically includes information that identifies the client and the status of the client (e.g., idle, game play, etc.). The heart beat message may also include diagnostic information. Hiccups between the server and client may be inevitable and therefore, in some cases, the heart beat message may be retried before deciding that something is wrong. For example, there may be a specified retry count that if exceeded, indicates that something is wrong. Furthermore, in order to conserve battery power, the heart beat message interval may be lengthened if it is determined that the client is idle.

Furthermore, the server system typically includes a state engine that keeps track of various points of each play and the historically record of each game. This ensures that the data is safe and provides a backup in cases where the client device goes offline. Although the results of a game may have been determined by the server, the play may still be considered unfinished. The play may be considered unfinished until the results are displayed at the client device. Therefore, in some cases, the client is configured to send an acknowledgement command back to the server stating that the results have been displayed in order to complete the game play. This ensures that the user was notified of the results.

One example of the client server relationship will now be described in conjunction with a standard video slot machine. The video slot machine includes a plurality of reels with various positions. Each reel position contains a symbol such as cherries, bars or sevens. In the basic game, the user selects the betting line, the amount of the bet and then spins the reels (e.g., typically by pressing a button or pulling a lever). Thereafter, each of the reels starts spinning through their various positions. The gaming logic of the gaming machine randomly selects what positions to stop each of the reels and thereafter the reels are stopped in accordance with this selection. A win is typically achieved when matching symbols are aligned along a betting line at the end of the spinning sequence.

In the context of the client server relationship, in response to a user selecting spin on the client machine, the client starts spinning the wheel displayed at the client device. In addition, the client sends a message to the server. The message indicates that spin has been selected (e.g., start of the game) as well as all other information about the bet as for example the bet type and amount. The server determines if the bet is valid, and if so the server randomly generates the stopping positions of each spinning reel. Thereafter, the server evaluates if the reels indicate a winner or a loser. In either case, it calculates the results of the win or loss including how much was won or lost, the new balance, etc. Thereafter, the server sends a message to the client instructing the client how to output the results. For example, the message may include instructions of where to stop the spinning reels as well as the financial information associated with the win or loss. Upon receiving the message, the client refers to its limited gaming code to determine how to stop the reels at the designated positions and which symbols to display. Once this is determined, the client initiates the stopping of the reels and presentation of the symbols on the display in accordance with the gaming code and adjusts the balance according to the win or loss.

In accordance with one embodiment, the client includes measures for securing select data on the client device against tampering. The select data may for example be any data that is associated with a game play including for example any data for displaying the game or results of the game. Generally, the measures include determining if the client device is trusted, and if not trusted immediately removing the select data from the client device. That is, the client device becomes aware that it is not trusted (for example it has lost communication with a server system) and executes a security command that wipes or erases the select data from memory. Because the client removes the select data as soon as it figures out that it can't be trusted, the device is difficult to examine and hack (thereby it provides an added level of security not normally afforded to client devices).

The select data may for example include executable code, binaries and resources associated with gaming (e.g., gaming data). The select data may also include all data stored on the client device including the entire system configuration (e.g., operating systems, log files and communication systems, etc.). It should be pointed out, however, that typically only the gaming data is wiped because of the amount of work required to reload the entire system configuration.

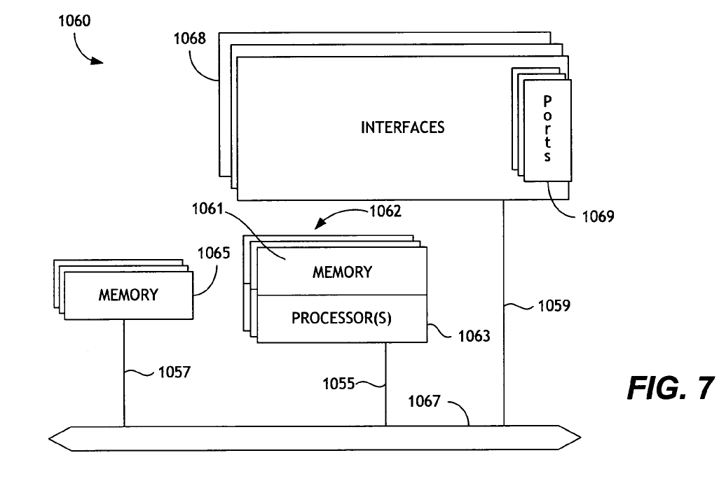

FIG. 5 shows a perspective view of a gaming machine 2 in accordance with a specific embodiment of the present invention. Any of the gaming devices and gaming functions described with respect to FIG. 5 can be incorporated in the clients described above with respect to FIGS. 1-4 or the devices described with respect to FIGS. 6 and 7. The gaming machine 2 is one example of a balance handling device that may be used with a game outcome server. In one embodiment, the gaming machine 2 may perform the functions of balance handling and also provide a client interface that allows a gaming activity generated on a game outcome server to be presented on the gaming machine.

As illustrated in the example of FIG. 5, machine 2 includes a main cabinet 4, which generally surrounds the machine interior and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a belly glass 40. Viewable through the main door is a video display monitor 34 and an information panel 36. The display monitor 34 will typically be a cathode ray tube, high resolution flat-panel LCD, or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2.

According to a specific embodiment, the devices may be controlled by code executed by a master gaming controller 46 housed inside the main cabinet 4 of the machine 2. The hardware and software associated with the master gaming controller 46 may be distributed throughout the cabinet 4 and is not limited to the specific location illustrated in the FIG. 5. In specific embodiments where it may be required that the code be periodically configured and/or authenticated in a secure manner, the technique of the present invention may be used for accomplishing such tasks.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

As illustrated in the example of FIG. 5, the gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 45. The ticket printer 18 may be used to print tickets for a cashless ticketing system. Further, the top box 6 may house different or additional devices not illustrated in FIG. 5. For example, the top box may include a bonus wheel or a back-lit silk screened panel, which may be used to add bonus features to the game being played on the gaming machine. As another example, the top box may include a display for a progressive jackpot offered on the gaming machine. During a game, these devices are controlled and powered, in part, by circuitry (e.g. a master gaming controller) housed within the main cabinet 4 of the machine 2.

It will be appreciated that gaming machine 2 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines of the present assignee are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

For example, a watchdog timer is normally used in International Game Technology (IGT) gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

IGT gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modern general-purpose computers include voltage monitoring circuitry, these types of circuits only report voltage status to the operating software. Out of tolerance voltages can cause software malfunction, creating a potential uncontrolled condition in the gaming computer. Gaming machines of the present assignee typically have power supplies with tighter voltage margins than that required by the operating circuitry. In addition, the voltage monitoring circuitry implemented in IGT gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for IGT gaming machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., balance) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion. Further details of a state based gaming system, recovery from malfunctions and game history are described in U.S. Pat. No. 6,804,763, titled “High Performance Battery Backed RAM Interface”, U.S. Pat. No. 6,863,608, titled “Frame Capture of Actual Game Play,” U.S. application Ser. No. 10/243,104, titled, “Dynamic NV-RAM,” and U.S. application Ser. No. 10/758,828, titled, “Frame Capture of Actual Game Play,” each of which is incorporated by reference and for all purposes.

Another feature of gaming machines, such as IGT gaming computers, is that they often include unique interfaces, including serial interfaces, to connect to specific subsystems internal and external to the gaming machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the gaming machine, serial devices may be connected in a shared, daisy-chain fashion where multiple peripheral devices are connected to a single serial channel.

The serial interfaces may be used to transmit information using communication protocols that are unique to the gaming industry. For example, IGT's Netplex is a proprietary communication protocol used for serial communication between gaming devices. As another example, SAS is a communication protocol used to transmit information, such as metering information, from a gaming machine to a remote device. Often SAS is used in conjunction with a player tracking system.

IGT gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into an IGT gaming machine by monitoring security switches attached to access doors in the gaming machine cabinet. Preferably, access violations result in suspension of game play and can trigger additional security operations to preserve the current state of game play. These circuits also function when power is off by use of a battery backup. In power-off operation, these circuits continue to monitor the access doors of the gaming machine. When power is restored, the gaming machine can determine whether any security violations occurred while power was off, e.g., via software for reading status registers. This can trigger event log entries and further data authentication operations by the gaming machine software.

Trusted memory devices and/or trusted memory sources are preferably included in an IGT gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the gaming machine. The code and data stored in these devices may include authentication algorithms, random number generators, authentication keys, operating system kernels, etc. The purpose of these trusted memory devices is to provide gaming regulatory authorities a root trusted authority within the computing environment of the gaming machine that can be tracked and verified as original. This may be accomplished via removal of the trusted memory device from the gaming machine computer and verification of the secure memory device contents is a separate third party verification device. Once the trusted memory device is verified as authentic, and based on the approval of the verification algorithms included in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 from U.S. patent application Ser. No. 09/925,098, filed Aug. 8, 2001 and titled “Process Verification,” which is incorporated herein in its entirety and for all purposes.

In at least one embodiment, at least a portion of the trusted memory devices/sources may correspond to memory which cannot easily be altered (e.g., “unalterable memory”) such as, for example, EPROMS, PROMS, BIOS, Extended BIOS., and/or other memory sources which are able to be configured, verified, and/or authenticated (e.g., for authenticity) in a secure and controlled manner.

According to a specific implementation, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment of the present invention, the remote device and the trusted information source may engage in methods using zero knowledge proofs to authenticate each of their respective identities.

Gaming devices storing trusted information may utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Additional details relating to trusted memory devices/sources are described in U.S. patent application Ser. No. 11/078,966, entitled “Secured Virtual Network in a Gaming Environment”, naming Nguyen et al. as inventors, filed on Mar. 10, 2005, herein incorporated in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, IGT gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present. Details using a mass storage device that may be used with the present invention are described, for example, in U.S. Pat. No. 6,149,522, herein incorporated by reference in its entirety for all purposes.

Returning to the example of FIG. 5, when a user wishes to play the gaming machine 2, he or she inserts cash through the coin acceptor 28 or bill validator 30. Additionally, the bill validator may accept a printed ticket voucher, which may be accepted by the bill validator 30 as indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 45 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights behind the belly glass 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

FIG. 6 shows a block diagram illustrating components of a gaming system 900 which may be used for implementing various aspects of the present invention. In FIG. 6, the components of a gaming system 900 for providing game software licensing and downloads are described functionally. The described functions may be instantiated in hardware, firmware and/or software and executed on a suitable device. In the system 900, there may be many instances of the same function, such as multiple game play interfaces 911. Nevertheless, in FIG. 6, only one instance of each function is shown. The functions of the components may be combined. For example, a single device may comprise the game play interface 911 and include trusted memory devices or sources 909. The described components and their functions may be incorporated various embodiments of the servers and clients described with respect to FIGS. 1-5.

The gaming system 900 may receive inputs from different groups/entities and output various services and or information to these groups/entities. For example, game players 925 primarily input cash or indicia of credit into the system, make game selections that trigger software downloads, and receive entertainment in exchange for their inputs. Game software content providers provide game software for the system and may receive compensation for the content they provide based on licensing agreements with the gaming machine operators. Gaming machine operators select game software for distribution, distribute the game software on the gaming devices in the system 900, receive revenue for the use of their software and compensate the gaming machine operators. The gaming regulators 930 may provide rules and regulations that must be applied to the gaming system and may receive reports and other information confirming that rules are being obeyed.

In the following paragraphs, details of each component and some of the interactions between the components are described with respect to FIG. 6. The game software license host 901 may be a server connected to a number of remote gaming devices that provides licensing services to the remote gaming devices. For example, in other embodiments, the license host 901 may 1) receive token requests for tokens used to activate software executed on the remote gaming devices, 2) send tokens to the remote gaming devices, 3) track token usage and 4) grant and/or renew software licenses for software executed on the remote gaming devices. The token usage may be used in utility based licensing schemes, such as a pay-per-use scheme.

In another embodiment, a game usage-tracking host 915 may track the usage of game software on a plurality of devices in communication with the host. The game usage-tracking host 915 may be in communication with a plurality of game play hosts and gaming machines. From the game play hosts and gaming machines, the game usage tracking host 915 may receive updates of an amount that each game available for play on the devices has been played and on amount that has been wagered per game. This information may be stored in a database and used for billing according to methods described in a utility based licensing agreement.

The game software host 902 may provide game software downloads, such as downloads of game software or game firmware, to various devious in the game system 900. For example, when the software to generate the game is not available on the game play interface 911, the game software host 902 may download software to generate a selected game of chance played on the game play interface. Further, the game software host 902 may download new game content to a plurality of gaming machines via a request from a gaming machine operator.

In one embodiment, the game software host 902 may also be a game software configuration-tracking host 913. The function of the game software configuration-tracking host is to keep records of software configurations and/or hardware configurations for a plurality of devices in communication with the host (e.g., denominations, number of paylines, paytables, max/min bets). Details of a game software host and a game software configuration host that may be used with the present invention are described in co-pending U.S. Pat. No. 6,645,077, by Rowe, entitled, “Gaming Terminal Data Repository and Information System,” filed Dec. 21, 2000, which is incorporated herein in its entirety and for all purposes.

A game play host device 903 may be a host server connected to a plurality of remote clients that generates games of chance that are displayed on a plurality of remote game play interfaces 911. For example, the game play host device 903 may be a server that provides central determination for a bingo game play played on a plurality of connected game play interfaces 911. As another example, the game play host device 903 may generate games of chance, such as slot games or video card games, for display on a remote client. A game player using the remote client may be able to select from a number of games that are provided on the client by the host device 903. The game play host device 903 may receive game software management services, such as receiving downloads of new game software, from the game software host 902 and may receive game software licensing services, such as the granting or renewing of software licenses for software executed on the device 903, from the game license host 901.

In particular embodiments, the game play interfaces or other gaming devices in the gaming system 900 may be portable devices, such as electronic tokens, cell phones, smart cards, tablet PC's and PDA's. The portable devices may support wireless communications and thus, may be referred to as wireless mobile devices. The network hardware architecture 916 may be enabled to support communications between wireless mobile devices and other gaming devices in gaming system. In one embodiment, the wireless mobile devices may be used to play games of chance.

The gaming system 900 may use a number of trusted information sources. Trusted information sources 904 may be devices, such as servers, that provide information used to authenticate/activate other pieces of information. CRC values used to authenticate software, license tokens used to allow the use of software or product activation codes used to activate to software are examples of trusted information that might be provided from a trusted information source 904. Trusted information sources may be a memory device, such as an EPROM, that includes trusted information used to authenticate other information. For example, a game play interface 911 may store a private encryption key in a trusted memory device that is used in a private key-public key encryption scheme to authenticate information from another gaming device.

When a trusted information source 904 is in communication with a remote device via a network, the remote device will employ a verification scheme to verify the identity of the trusted information source. For example, the trusted information source and the remote device may exchange information using public and private encryption keys to verify each other's identities.

Gaming devices storing trusted information might utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

The gaming system 900 of the present invention may include devices 906 that provide authorization to download software from a first device to a second device and devices 907 that provide activation codes or information that allow downloaded software to be activated. The devices, 906 and 907, may be remote servers and may also be trusted information sources. One example of a method of providing product activation codes that may be used with the present invention is describes in previously incorporated U.S. Pat. No. 6,264,561.

A device 906 that monitors a plurality of gaming devices to determine adherence of the devices to gaming jurisdictional rules 908 may be included in the system 900. In one embodiment, a gaming jurisdictional rule server may scan software and the configurations of the software on a number of gaming devices in communication with the gaming rule server to determine whether the software on the gaming devices is valid for use in the gaming jurisdiction where the gaming device is located. For example, the gaming rule server may request a digital signature, such as CRC's, of particular software components and compare them with an approved digital signature value stored on the gaming jurisdictional rule server.

Further, the gaming jurisdictional rule server may scan the remote gaming device to determine whether the software is configured in a manner that is acceptable to the gaming jurisdiction where the gaming device is located. For example, a maximum bet limit may vary from jurisdiction to jurisdiction and the rule enforcement server may scan a gaming device to determine its current software configuration and its location and then compare the configuration on the gaming device with approved parameters for its location.

A gaming jurisdiction may include rules that describe how game software may be downloaded and licensed. The gaming jurisdictional rule server may scan download transaction records and licensing records on a gaming device to determine whether the download and licensing was carried out in a manner that is acceptable to the gaming jurisdiction in which the gaming device is located. In general, the game jurisdictional rule server may be utilized to confirm compliance to any gaming rules passed by a gaming jurisdiction when the information needed to determine rule compliance is remotely accessible to the server.

Game software, firmware or hardware residing a particular gaming device may also be used to check for compliance with local gaming jurisdictional rules. In one embodiment, when a gaming device is installed in a particular gaming jurisdiction, a software program including jurisdiction rule information may be downloaded to a secure memory location on a gaming machine or the jurisdiction rule information may be downloaded as data and utilized by a program on the gaming machine. The software program and/or jurisdiction rule information may used to check the gaming device software and software configurations for compliance with local gaming jurisdictional rules. In another embodiment, the software program for ensuring compliance and jurisdictional information may be installed in the gaming machine prior to its shipping, such as at the factory where the gaming machine is manufactured.

The gaming devices in game system 900 may utilize trusted software and/or trusted firmware. Trusted firmware/software is trusted in the sense that is used with the assumption that it has not been tampered with. For instance, trusted software/firmware may be used to authenticate other game software or processes executing on a gaming device. As an example, trusted encryption programs and authentication programs may be stored on an EPROM on the gaming machine or encoded into a specialized encryption chip. As another example, trusted game software, i.e., game software approved for use on gaming devices by a local gaming jurisdiction may be required on gaming devices on the gaming machine.

In the present invention, the devices may be connected by a network 916 with different types of hardware using different hardware architectures. Game software can be quite large and frequent downloads can place a significant burden on a network, which may slow information transfer speeds on the network. For game-on-demand services that require frequent downloads of game software in a network, efficient downloading is essential for the service to viable. Thus, in the present inventions, network efficient devices 910 may be used to actively monitor and maintain network efficiency. For instance, software locators may be used to locate nearby locations of game software for peer-to-peer transfers of game software. In another example, network traffic may be monitored and downloads may be actively rerouted to maintain network efficiency.

One or more devices in the present invention may provide game software and game licensing related auditing, billing and reconciliation reports to server 912. For example, a software licensing billing server may generate a bill for a gaming device operator based upon a usage of games over a time period on the gaming devices owned by the operator. In another example, a software auditing server may provide reports on game software downloads to various gaming devices in the gaming system 900 and current configurations of the game software on these gaming devices.

At particular time intervals, the software auditing server 912 may also request software configurations from a number of gaming devices in the gaming system. The server may then reconcile the software configuration on each gaming device. In one embodiment, the software auditing server 912 may store a record of software configurations on each gaming device at particular times and a record of software download transactions that have occurred on the device. By applying each of the recorded game software download transactions since a selected time to the software configuration recorded at the selected time, a software configuration is obtained. The software auditing server may compare the software configuration derived from applying these transactions on a gaming device with a current software configuration obtained from the gaming device. After the comparison, the software-auditing server may generate a reconciliation report that confirms that the download transaction records are consistent with the current software configuration on the device. The report may also identify any inconsistencies. In another embodiment, both the gaming device and the software auditing server may store a record of the download transactions that have occurred on the gaming device and the software auditing server may reconcile these records.

There are many possible interactions between the components described with respect to FIG. 6. Many of the interactions are coupled. For example, methods used for game licensing may affect methods used for game downloading and vice versa. For the purposes of explanation, details of a few possible interactions between the components of the system 900 relating to software licensing and software downloads have been described. The descriptions are selected to illustrate particular interactions in the game system 900. These descriptions are provided for the purposes of explanation only and are not intended to limit the scope of the present invention.

FIG. 7 illustrates an example of a network device that may be configured for implementing some methods of the present invention, such as methods described with respect to a player management server or game outcome server. Network device 1060 includes a master central processing unit (CPU) 1062, interfaces 1068, and a bus 1067 (e.g., a PCI bus). Generally, interfaces 1068 include ports 1069 appropriate for communication with the appropriate media. In some embodiments, one or more of interfaces 1068 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1068 control such communications-intensive tasks as encryption, decryption, compression, decompression, packetization, media control and management. By providing separate processors for the communications-intensive tasks, interfaces 1068 allow the master microprocessor 1062 efficiently to perform other functions such as routing computations, network diagnostics, security functions, etc.

The interfaces 1068 are typically provided as interface cards (sometimes referred to as “linecards”). Generally, interfaces 1068 control the sending and receiving of data packets over the network and sometimes support other peripherals used with the network device 1060. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1062 may be responsible for implementing specific functions associated with the functions of a desired network device. According to some embodiments, CPU 1062 accomplishes all these functions under the control of software including an operating system and any appropriate applications software.

CPU 1062 may include one or more processors 1063 such as a processor from the Motorola family of microprocessors or the MIPS family of microprocessors. In an alternative embodiment, processor 1063 is specially designed hardware for controlling the operations of network device 1060. In a specific embodiment, a memory 1061 (such as non-volatile RAM and/or ROM) also forms part of CPU 1062. However, there are many different ways in which memory could be coupled to the system. Memory block 1061 may be used for a variety of purposes such as, for example, caching and/or storing data, programming instructions, etc.

Regardless of network device's configuration, it may employ one or more memories or memory modules (such as, for example, memory block 1065) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 7 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 7) or switch fabric based (such as a cross-bar).

Although the foregoing invention has been described in detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not to be limited by the foregoing details, but rather is to be defined by the scope of the appended claims.

What is claimed is:

1. A gaming system comprising,
a target device comprising:
a first logic device designed or configured to 1) receive encrypted game data from a source device; 2) generate a first value by applying a first one-way function to the encrypted game data; 3) send the first value to an authorization device; 4) receive a decryption key from the authorization device for revealing game data from the encrypted game data; 5) generate a second value by applying a second one-way function to the game data; 6) send the second value to the authorization device, 7) receive an authorization message from the authorization device indicating whether the target device is authorized to use the game data; 8) generate a play of a wager-based game using the game data;
a display for displaying an outcome to the wager-based game;
a first communication interface for communicating with the source device and the authorization device;
a source device comprising
a memory for storing the game data;
a second logic device designed or configured to 1) receive an encryption key from the authorization device; 2) embed at least a portion of the encryption key in the game data; 3) to encrypt the game data embedded with at least the portion of the encryption key with the encryption key; 4) to send the encrypted game data to the target device;
a second communication interface for communicating with the authorization device and the target device;
the authorization device comprising:
a memory storing the game data wherein the game data is an authorized copy of the game data stored on the source device;
a third logic device designed or configured to receive a plurality of download requests and for each download request, a) to generate a new encryption key pair including the encryption key and the decryption key wherein the new encryption key pair is used only one time; b) to embed at least the portion of the encryption key in the game data in the same manner as the source device; c) to generate a third value by applying the second one-way function to the game data including the embedded encryption key; d) to encrypt the game data embedded with at least the portion of the encryption key with the encryption key; e) to generate a fourth value by applying the first one-way function to the encrypted game data; f) to receive from the target device the first value, g) to compare the first value to the fourth value; h) when it is determined the first value and the fourth value match, to send to the target device the decryption key, i) to receive from the target device, the second value; j) to compare the second value to the third value; k) when it is determined the second value and third value match, to send the authorization message to the target device indicating it is authorized to use the game data it received from the source device.

2. The gaming system of claim 1, wherein the first one-way function or the second one-way function is a hash function.

3. The gaming system of claim 1, wherein the third logic device is further designed or configured to send a message to the target device specifying the first one-way function to use, the second one-way function to use or the first one-way function and the second one-way function to use.

4. The gaming system of claim 1, wherein the third logic device is further designed or configured to select at random the first one-way function to use, the second one-way function to use or the first one-way function and the second one-way function to use.

5. The gaming system of claim 1, wherein the third logic device is further designed or configured to send a message to the target device including instructions to cease operations and to enter into a tilt state.

6. The gaming system of claim 1, wherein the third logic device is further designed or configured to send a message to the target device including instructions to delete the game data or the encrypted game data received from the source device.

7. The gaming system of claim 1, wherein the third logic device is further designed or configured to send a message to the target device indicating one or more portions of the game data or one or more portions of the encrypted game data for use with the first one-way function or for use with the second one-way function.

8. The gaming system of claim 1, wherein the game data comprises coding instructions used to generate the wager-based game of chance on the target device.

9. The gaming system of claim 1, wherein the game data comprises one of data in a textual format, data in a binary format or combinations thereof.

10. The gaming system of claim 1, wherein the target device is a hand-held gaming device.

11. The gaming system of claim 1, wherein target device is designed or configured to only store the game data while in a power-on configuration.

12. The gaming system of claim 1, wherein the target device is designed or configured to erase the game data in response to receiving instructions from the authorization device.

13. The gaming system of claim 1, wherein the target device is inoperable to generate the play of the wager-based game prior to receiving the game data from the source device.

14. The gaming system of claim 1, wherein the source is a gaming device operable to generate the play of the wager-based game.

15. The gaming system of claim 1, wherein the authorization device and the source device are a common device.

16. The gaming system of claim 1, wherein the authorization device, the source device and the authentication device are communicatively coupled via a network.

17. The gaming system of claim 1, wherein the authorization device is located in a secure location separate from the source device.

18. The gaming system of claim 1, wherein the authorization device is operated by a trusted entity.

19. The gaming system of claim 1, wherein the trusted entity is a gaming regulator.

20. The gaming system of claim 1, wherein each time a copy of the game data is sent from the source device, different randomly generated data is embedded in the copy of the sent game data so that a value generated by application of a one-way function to a first copy of the sent game data is different than a value generated by application of the one-way function to a second copy of the sent game data.
